(19) United States
(12) Patent Application Publication
(10) Pub. No.: US 2021/0166090 A1
(43) Pub. Date: Jun. 3, 2021

(54) DRIVING ASSISTANCE FOR THE LONGITUDINAL AND/OR LATERAL CONTROL OF A MOTOR VEHICLE

(71) Applicant: Valeo Schalter und Sensoren GmbH, Bietigheim-Bissingen (DE)

(72) Inventors: Thibault Buhet, Creteil (FR); Laurent George, Creteil (FR)

(73) Assignee: Valeo Schalter und Sensoren GmbH, Bietigheim-Bissingen (DE)

(21) Appl. No.: 17/264,125

(22) PCT Filed: Jul. 30, 2019
(86) PCT No.: PCT/EP2019/070447

§ 371 Date: Jan. 28, 2021

(30) Foreign Application Priority Data
Jul. 31, 2018 (FR) 1857180

(51) Int. Cl. G06K 9/62; G06T 3/40; G06K 9/00; G06T 3/60; B60W 10/04; B60W 10/20; G06N 3/04

(52) U.S. Cl. CPC G06K 9/6289; G06T 3/40; G06K 9/6217; G06K 9/00791; G06T 3/60; B60W 10/04; B60W 2720/12; G06N 3/04; G06T 2207/20132; G06T 2207/30261; B60W 2420/42; B60W 2720/10; B60W 10/20

(57) ABSTRACT

The invention relates to a driving assistance system (3) for the longitudinal and/or lateral control of a motor vehicle, comprising an image processing device (31a) trained beforehand using a learning algorithm and configured so as to generate, at output, a control instruction (S_{com1}) for the motor vehicle from an image (Im₁) provided at input and captured by an on-board digital camera (2); a digital image processing module (32) configured so as to provide at least one additional image (Im₂) at input of an additional device (31b), identical to the device (31a), for parallel processing of the image (Im₁) captured by the camera (2) and said at least one additional image (Im₂), such that said additional device (31b) generates at least one additional control instruction (S_{com2}) for the motor vehicle, said additional image (Im₂) resulting from at least one geometric and/or radiometric transformation performed on said captured image (Im₁), and a digital fusion module (33) configured so as to generate a resultant control instruction (S_{com}) on the basis of said control instruction (S_{com1}) and of said at least one additional control instruction (S_{com2}).

The present invention relates in general to motor vehicles, and more precisely to a driving assistance method and system for the longitudinal and/or lateral control of a motor vehicle.

Numerous driving assistance systems are nowadays offered for the purpose of improving traffic safety conditions.

Among the possible functionalities, mention may be made in particular of speed control or ACC (initials used for adaptive cruise control), automatic stopping and restarting of the engine of the vehicle on the basis of the traffic conditions and/or signals (traffic lights, stop signs, give way signs, etc.), assistance for automatically keeping the trajectory of the vehicle within its running lane, as proposed by systems known as lane keeping assistance systems, warning the driver about leaving a lane or unintentionally crossing lines (lane departure warning), assistance with changing lanes or LCC (lane change control), etc.

Driving assistance systems thus have the general role of warning the driver about a situation requiring his attention and/or of defining the trajectory that the vehicle should follow in order to arrive at a given destination, and thereby making it possible to control the units for controlling the steering and/or braking and acceleration of the vehicle, so that this trajectory is effectively automatically followed. The trajectory should be understood in this case in terms of its mathematical definition, that is to say as being the set of successive positions that have to be occupied by the vehicle over time. Driving assistance systems thus have to define not only the path to be taken, but also the speed (or acceleration) profile to be complied with. For this purpose, they use numerous information regarding the immediate surroundings of the vehicle (presence of obstacles such as pedestrians, bicycles or other motorized vehicles, detection of signposts, road configuration, etc.) coming from one or more detection means such as cameras, radars, lidars, fitted to the vehicle, as well as information linked to the vehicle itself, such as its speed, its acceleration, and its position given for example by a GPS navigation system.

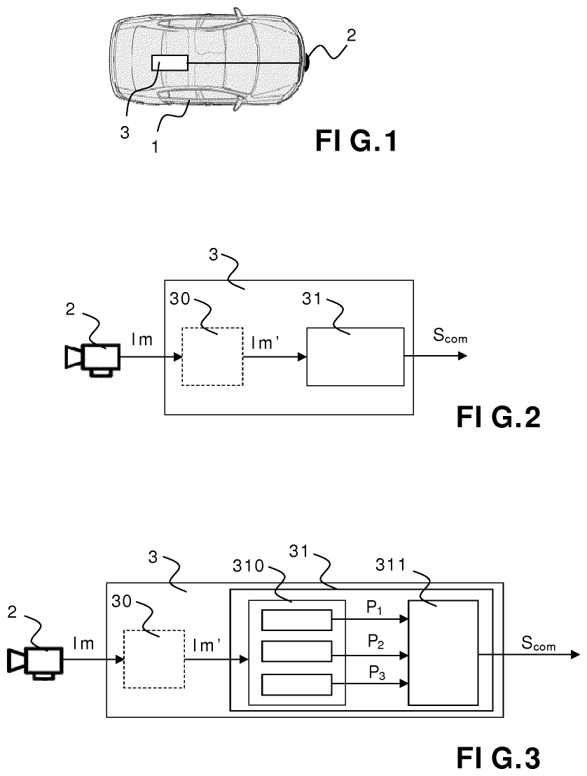

What are of more particular interest hereinafter are driving assistance systems for the longitudinal and/or lateral control of a motor vehicle based only on processing the images captured by a camera housed on board the motor vehicle. FIG. 1 schematically illustrates a plan view of a motor vehicle 1 equipped with a digital camera 2, placed here at the front of the vehicle, and with a driving assistance system 3 receiving the images captured by the camera at input.

Some of these systems implement viewing algorithms of different kinds (pixel processing, object recognition through automatic learning, optical flows) in order to detect obstacles or more generally objects in the immediate surroundings of the vehicle, to estimate a distance between the vehicle and the detected obstacles, and to accordingly control the units of the vehicle such as the steering wheel or steering column, the braking units and/or the accelerator. These systems make it possible to recognize only a limited number of objects (for example pedestrians, cyclists, other cars, signposts, animals, etc.) that are defined in advance.

Other systems use artificial intelligence and attempt to imitate human behaviour in the face of a complex road scene. The document entitled “End to End Learning for Self-Driving Cars” (M. Bojarski et al., 25 Apr. 2016, https://arxiv.org/abs/1604.07316) in particular discloses a convolutional neural network or CNN, which network, once trained in an “offline” learning process, is able to generate a steering instruction from the video image provided by a camera.

The “online” operation of one known system 3 of this type is shown schematically in FIG. 2. The system 3 comprises a neural network 31, for example a deep neural network or DNN, and optionally a module 30 for redimensioning the images in order to generate an input image Im′ for the neural network, the dimensions of which are compatible with the network, from an image Im provided by a camera 2. The neural network forming the image processing device 31 has been trained beforehand and configured so as to generate, at output, a control instruction S_{com}, for example a (positive or negative) setpoint acceleration or speed for the vehicle when it is desired to exert longitudinal control of the motor vehicle, or a setpoint steering angle of the steering wheel when it is desired to exert lateral control of the vehicle, or even a combination of these two types of instruction if it is desired to exert longitudinal and lateral control.

In another known implementation of an artificial-intelligence driving assistance system, shown schematically in FIG. 3, the image Im captured by the camera 2, possibly redimensioned to form an image Im′, is processed in parallel by a plurality of neural networks in a module 310, each of the networks having been trained for a specific task. Three neural networks have been shown in FIG. 3, each generating an instruction P₁, P₂ or P₃ for the longitudinal and/or lateral control of the vehicle, from one and the same input image Im′. The instructions are then fused in a digital module 311 so as to deliver a resultant longitudinal and/or lateral control instruction S_{com}.

In both cases, the neural networks have been trained based on a large number of image records corresponding to real driving situations of various vehicles involving various humans, and have thus learned to recognize a scene and to generate a control instruction close to human behaviour.

The benefit of artificial-intelligence systems such as the neural networks described above lies in the fact that these systems will be able to simultaneously apprehend a large number of parameters in a road scene (for example a decrease in brightness, the presence of several obstacles of several kinds, the presence of a car in front of the vehicle and whose rear lights are turned on, curved and/or fading marking lines on the road, etc.) and respond in the same way as a human driver would. However, unlike object detection systems, artificial-intelligence systems do not necessarily classify or detect objects, and therefore do not necessarily estimate information on the distance between the vehicle and a potential hazard.

Now, in usage conditions, it may be the case that the control instruction is not responsive enough, thereby possibly creating hazardous situations. For example, the system 3 described in FIGS. 2 and 3 may, in some cases, not sufficiently anticipate the presence of another vehicle ahead of the vehicle 1, thereby possibly leading for example to delayed braking.

A first possible solution would be to combine the instruction S_{com} with distance information coming from another sensor housed on board the vehicle (for example a lidar or a radar, etc.). This solution is however expensive.

Another solution would be to modify the algorithms implemented in the neural network or networks of the device 31. In this case too, the solution is expensive. In addition, it is not always possible to act on the content of this device 31.

Furthermore, although the above solutions make it possible to manage possible errors in the network when appreciating the situation, none of them makes it possible to anticipate the computing time of the algorithms or to modify the behaviour of the vehicle so that it adopts a particular driving style, such as safe driving, or more aggressive driving.

The present invention aims to mitigate the limitations of the above systems by providing a simple and inexpensive solution that makes it possible to improve the responsiveness of the algorithm implemented by the device 31 without having to modify its internal processing process.

To this end, a first subject of the invention is a driving assistance method for the longitudinal and/or lateral control of a motor vehicle, the method comprising a step of processing an image captured by a digital camera housed on board said motor vehicle using a processing algorithm that has been trained beforehand by a learning algorithm, so as to generate a longitudinal and/or lateral control instruction for the motor vehicle, the method being characterized in that it furthermore comprises:

at least one additional processing step, in parallel with said step of processing the image, of additionally processing at least one additional image using said processing algorithm, so as to generate at least one additional longitudinal and/or lateral control instruction for the motor vehicle, said at least one additional image resulting from at least one geometric and/or radiometric transformation performed on said captured image, and

generating a resultant longitudinal and/or lateral control instruction on the basis of said longitudinal and/or lateral control instruction and of said at least one additional longitudinal and/or lateral control instruction.

According to one possible implementation of the method according to the invention, said at least one geometric and/or radiometric transformation comprises zooming, magnifying a region of interest of said captured image.

According to other possible implementations, said at least one geometric and/or radiometric transformation comprises rotating, and/or modifying the brightness, and/or cropping said captured image or a region of interest of said captured image.

In one possible implementation, said longitudinal and/or lateral control instruction and said at least one additional longitudinal and/or lateral control instruction comprise information relating to a setpoint steering angle of the steering wheel of the motor vehicle.

As a variant or in combination, said longitudinal and/or lateral control instruction and said at least one additional longitudinal and/or lateral control instruction comprise information relating to a setpoint speed and/or a setpoint acceleration.

Said resultant longitudinal and/or lateral control instruction may be generated by calculating an average of said longitudinal and/or lateral control instruction and said at least one additional longitudinal and/or lateral control instruction. As a variant, said resultant longitudinal and/or lateral control instruction may correspond to a minimum value out of a setpoint speed in relation to said longitudinal and/or lateral control instruction and an additional setpoint speed in relation to said at least one additional longitudinal and/or lateral control instruction.

A second subject of the present invention is a driving assistance system for the longitudinal and/or lateral control of a motor vehicle, the system comprising an image processing device intended to be housed on board the motor vehicle, said image processing device having been trained beforehand using a learning algorithm and being configured so as to generate, at output, a longitudinal and/or lateral control instruction for the motor vehicle from an image captured by an on-board digital camera and provided at input, the system being characterized in that it furthermore comprises:

at least one additional image processing device identical to said image processing device;

a digital image processing module configured so as to provide at least one additional image at input of said additional image processing device for parallel processing of the image captured by the camera and said at least one additional image, such that said additional image processing device generates at least one additional longitudinal and/or lateral control instruction for the motor vehicle, said at least one additional image resulting from at least one geometric and/or radiometric transformation performed on said image, and

a digital fusion module configured so as to generate a resultant longitudinal and/or lateral control instruction on the basis of said longitudinal and/or lateral control instruction and of said at least one additional longitudinal and/or lateral control instruction.

The invention will be better understood upon reading the following description, given with reference to the appended figures, in which:

FIG. 1, already described above, illustrates, in simplified form, an architecture shared by the driving assistance systems, housed on board a vehicle implementing processing of images coming from an on-board camera;

FIG. 2, already described above, is a simplified overview of a known system for the longitudinal and/or lateral control of a motor vehicle, using a neural network;

FIG. 3, already described above, is a known variant of the system from FIG. 2;

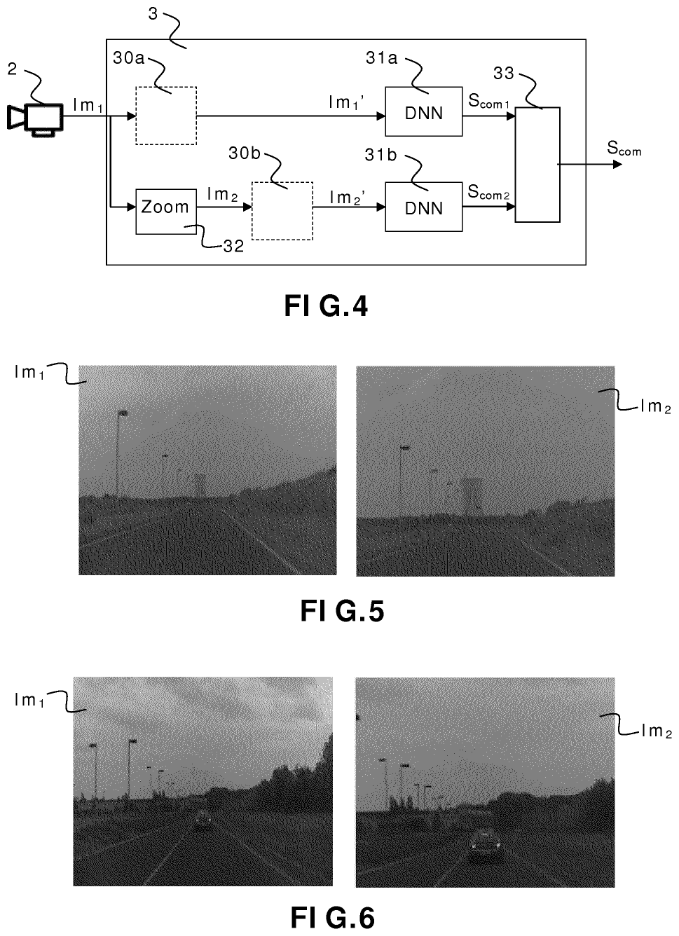

FIG. 4 shows, in the form of a simplified overview, one possible embodiment of a driving assistance system according to the invention;

FIGS. 5 and 6 illustrate principles applied by the system from FIG. 4 to two exemplary road situations.

In the remainder of the description, and unless provision is made otherwise, elements common to all of the figures bear the same references.

A driving assistance system according to the invention will be described with reference to FIG. 4, in the context of the longitudinal control of a motor vehicle. The invention is however not limited to this example, and may in particular be used to allow lateral control of a motor vehicle, or to allow both longitudinal and lateral control of a motor vehicle. In FIG. 4, the longitudinal control assistance system 3 comprises, as described in the context of the prior art, an image processing device 31a housed on board the motor vehicle, receiving, at input, an image Im₁ captured by a digital camera 2 also housed on board the motor vehicle. The image processing device 31a has been trained beforehand using a learning algorithm and configured so as to generate, at output, a longitudinal control instruction S_{com1}, for example a setpoint speed value or a setpoint acceleration, suited to the situation shown in the image Im₁. The device 31a may be the device 31 described with reference to FIG. 2, or the device 31 described with reference to FIG. 3. If necessary, the system comprises a redimensioning module 30a configured so as to redimension the image Im₁ to form an image Im₁′ that is compatible with the image size that the device 31a is able to process.

The image processing device 31a comprises for example a deep neural network.

The image processing device 31a is considered here to be a black box, in the sense that the invention proposes to improve the responsiveness of the algorithm that it implements without acting on its internal operation.

To this end, the invention makes provision to perform, in parallel with the processing performed by the device 31a, at least one additional processing operation using the same algorithm as the one implemented by the device 31a, on an additional image formulated from the image Im₁.

To this end, according to one possible embodiment of the invention, the system 3 comprises a digital image processing module 32 configured so as to provide at least one additional image Im₂ at input of an additional image processing device 31b, identical to the device 31a and accordingly implementing the same processing algorithm, this additional image Im₂ resulting from at least one geometric and/or radiometric transformation performed on the image Im₁ initially captured by the camera 2. In this case too, the system 3 may comprise a redimensioning module 30b similar to the redimensioning module 30a, in order to provide an image Im₂′ compatible with the input of the additional device 31b.

As illustrated by way of non-limiting example in FIG. 4, the digital module 32 is configured so as to perform zooming, magnifying a region of interest of the image Im₁ captured by the camera 2, for example a central region of the image Im₁. FIGS. 5 and 6 give two exemplary transformed images Im₂ resulting from zooming, magnifying the centre of an image Im₁ captured by a camera housed on board at the front of a vehicle. In the case of FIG. 5, the road scene ahead of the vehicle, shown in the image Im₁, shows a completely clear straight road ahead of the vehicle. In contrast, the image Im₁ in FIG. 6 shows the presence, ahead of the vehicle, of another vehicle whose rear stop lights are turned on. For both FIGS. 5 and 6, the image Im₂ is a zoomed image, magnifying the central region of the image Im₁. In the case of a hazard being present (situation in FIG. 6), the magnifying zoom gives the impression that the other vehicle is far closer than it actually is.

The system 3 according to the invention will thus be able to perform at least two parallel processing operations, specifically:

a first processing operation on the captured image Im₁ (possibly on the redimensioned image Im₁′) performed by the device 31a, allowing it to generate a control instruction S_{com1};

at least one second processing operation on the additional image Im₂ (possibly on the additional redimensioned image Im₂′) performed by the additional device 31b, allowing it to generate an additional control instruction S_{com2}, possibly separate from the control instruction S_{com1}.

The instruction S_{com1} and the additional instruction S_{com2} are of the same kind, and each comprise for example information relating to a setpoint speed to be adopted by the motor vehicle equipped with the system 3. As a variant, the two instructions S_{com1} and S_{com2} may each comprise a setpoint acceleration, having a positive value when the vehicle has to accelerate, or having a negative value when the vehicle has to slow down.

In other embodiments for which the system 3 should allow driving assistance with lateral control of the motor vehicle, the two instructions S_{com1} and S_{com2} will each comprise information preferably relating to a setpoint steering angle of the steering wheel of the motor vehicle.

In the example of the road situation shown in FIG. 5, the magnifying zoom will not have any real impact, since neither of the images Im₁ and Im₂ represent the existence of a hazard. The two processing operations performed in parallel will in this case generate two instructions S_{com1} and S_{com2} that are probably identical or similar.

On the other hand, for the example of the road situation shown in FIG. 6, the additional instruction S_{com2} will correspond to a setpoint deceleration whose value will be far higher than for the instruction S_{com1}, due to the fact that the device 31b will judge that the other vehicle is far closer and that it is necessary to brake earlier.

The system 3 according to the invention furthermore comprises a digital fusion module 33 connected at output of the processing devices 31a and 31b and receiving the instructions S_{com1} and S_{com2} at input.

The digital fusion module 33 is configured so as to generate a resultant longitudinal control instruction S_{com} on the basis of the instructions that it receives at input, in this case on the basis of the instruction S_{com1} resulting from the processing of the captured image Im₁, and of the additional instruction S_{com2} resulting from the processing of the image Im₂. Various fusion rules may be applied at this level so as to correspond to various driving styles.

For example, if the instruction S_{com1} corresponds to a setpoint speed for the motor vehicle and the additional instruction S_{com2} corresponds to an additional setpoint speed for the motor vehicle, the digital fusion module 33 will be able to generate:

a resultant instruction S_{com} corresponding to the minimum value out of the setpoint speed and the additional setpoint speed, for what is called a “safe” driving style; or

a resultant instruction S_{com} corresponding to the average value of the setpoint speed and the additional setpoint speed, for what is called a “conventional” driving style.

A geometric transformation other than the magnifying zoom may be contemplated without departing from the scope of the present invention. By way of non-limiting example, there may in particular be provision to configure the digital module 32 so that it rotates, crops or deforms the image Im₁ or a region of interest of this image Im₁.

A radiometric transformation, for example modifying the brightness or the contrast, may also be beneficial in terms of improving the responsiveness of the algorithm implemented by the devices 31a and 31b.

Of course, all or some of these transformations may be combined so as to produce a transformed image Im₂.

As a variant, there may be provision for the system 3 to comprise a plurality of additional processing operations performed in parallel, each processing operation comprising a predefined transformation of the captured image Im₁ into a second image Im₂, and the generation of an associated instruction by a device identical to the device 31a. By way of example, it is possible, on one and the same image Im₁, to perform various zooming at various scales, or to modify the brightness to various degrees, or to perform several transformations of various kinds.

The benefit of these parallel processing operations is that of being able to generate a plurality of possibly different instructions from transformations performed on one and the same image, so as to improve the overall behaviour of the algorithm used by the device 31a.

The fusion rules applied based on this plurality of instructions may be diverse depending on whether or not preference is given to safety. By way of example, the digital fusion module may be configured so as to generate:

a resultant instruction S_{com} corresponding to the minimum value out of the various setpoint speeds resulting from the various processing operations, for what is called a “safe” driving style; or

a resultant instruction S_{com} corresponding to the average value of the various setpoint speeds resulting from the various processing operations, for what is called a “conventional” driving style; or

a resultant instruction S_{com} corresponding to the average value of the two highest setpoint speeds resulting from the various processing operations, for what is called an “aggressive” driving style.

1. A driving assistance method for the longitudinal and/or lateral control of a motor vehicle, the method comprising:
processing an image captured by a digital camera housed on board said motor vehicle using a processing algorithm that has been trained beforehand by a machine learning algorithm, so as to generate a longitudinal and/or lateral control instruction for the motor vehicle;
in parallel with said step of processing the image, at least one additional image using said processing algorithm, so as to generate at least one additional longitudinal and/or lateral control instruction for the motor vehicle, said at least one additional image resulting from at least one geometric and/or radiometric transformation performed on said captured image; and
generating a resultant longitudinal and/or lateral control instruction on the basis of said longitudinal and/or lateral control instruction and of said at least one additional longitudinal and/or lateral control instruction.

2. The method according to claim 1, wherein said at least one geometric and/or radiometric transformation comprises zooming, magnifying a region of interest of said captured image.

3. The method according to claim 1, wherein said at least one geometric and/or radiometric transformation comprises rotating, or modifying the brightness, or cropping said captured image or a region of interest of said captured image.

4. The method according to claim 1, wherein said longitudinal and/or lateral control instruction and said at least one additional longitudinal and/or lateral control instruction comprise information relating to a setpoint steering angle of the steering wheel of the motor vehicle.

5. The method according to claim 1, wherein said longitudinal and/or lateral control instruction and said at least one additional longitudinal and/or lateral control instruction comprise information relating to a setpoint speed and/or a setpoint acceleration.

6. The method according to claim 5, wherein said resultant longitudinal and/or lateral control instruction is generated by calculating an average of said longitudinal and/or lateral control instruction and said at least one additional longitudinal and/or lateral control instruction.

7. The method according to claim 5, wherein said resultant longitudinal and/or lateral control instruction corresponds to a minimum value out of a setpoint speed in relation to said longitudinal and/or lateral control instruction and an additional setpoint speed in relation to said at least one additional longitudinal and/or lateral control instruction.

8. A driving assistance system for the longitudinal and/or lateral control of a motor vehicle, the system comprising:
an image processing device housed on board the motor vehicle, said image processing device having been trained beforehand using a machine learning algorithm and being configured to generate, at output, a longitudinal and/or lateral control instruction for the motor vehicle from an image;
an on-board digital camera configured to generate the image;
at least one additional image processing device identical to said image processing device;
a digital image processing module configured to provide at least one additional image at input of said additional image processing device for parallel processing of the image captured by the camera and said at least one additional image,
such that said additional image processing device generates at least one additional longitudinal and/or lateral control instruction for the motor vehicle,
said at least one additional image resulting from at least one geometric and/or radiometric transformation performed on said image; and
a digital fusion module configured so as to generate a resultant longitudinal and/or lateral control instruction on the basis of said longitudinal and/or lateral control instruction and of said at least one additional longitudinal and/or lateral control instruction.

9. A system according to claim 8, wherein the machine learning algorithm comprises a deep neural network.
